(19) United States
(12) Patent Application Publication
(10) Pub. No.: US 2023/0186243 A1
(43) Pub. Date: Jun. 15, 2023

(54) SMART CONTRACT-BASED PROJECT DEVELOPMENT USING MILESTONE BASED DISTRIBUTION

(71) Applicant: Blockcities, Inc., Salt Lake City, UT (US)

(72) Inventor: BRIAN CHRISTENSEN, Salt Lake City, UT (US)

(73) Assignee: Blockcities, Inc., Salt Lake City, UT (US)

(21) Appl. No.: 17/741,266

(22) Filed: May 10, 2022

Related U.S. Application Data
(60) Provisional application No. 63/186,786, filed on May 10, 2021.

(51) Int. Cl. G06Q 10/10; G06Q 30/08; G06Q 20/38; G06Q 20/10; G06Q 20/06; G06Q 20/40

(52) U.S. Cl. CPC G06Q 10/103; G06Q 30/08; G06Q 20/389; G06Q 20/10; G06Q 20/065; G06Q 20/401; G06Q 20/3821

(57) ABSTRACT

Apparatuses, methods, systems, and program products are disclosed for smart contract-based project development using milestone based distribution. A method includes generating a smart contract, using blockchain, for a project comprising a plurality of tasks, the smart contract comprising a plurality of milestones corresponding to the plurality of tasks. The method includes posting each of the plurality of tasks to be bid on by third parties to complete each task of the plurality of tasks. The method includes associating a third party that is granted the bid for a task with the corresponding milestone in the smart contract. The method includes, in response to authenticating information evidencing completion of the task by the third party, executing a portion of the smart contract associated with the milestone corresponding to the completed task, via the blockchain, to distribute funds to the third party that completed the task.

### CROSS-REFERENCE TO RELATED APPLICATIONS

This application claims the benefit of U.S. Provisional Patent Application No. 63/186,786 entitled “PROGRAMMABLE CONSTRUCTION USING SMART CONTRACTS WITH ESCROW DISTRIBUTION AND VERIFICATION BY PROFESSIONALS” and filed on May 10, 2021, for Brian Christensen, which is incorporated herein by reference.

### FIELD

This invention relates to software-based contracts using blockchain and more particularly relates to smart contract-based project development using milestone based distribution.

### BACKGROUND

Smart contracts permit trusted transactions and agreements to be carried out among disparate, anonymous parties without the need for a central authority, legal system, or external enforcement mechanism

### SUMMARY

Apparatuses, methods, systems, and program products are disclosed for smart contract-based project development using milestone based distribution. In one embodiment, a method includes generating a smart contract, using blockchain, for a project comprising a plurality of tasks, the smart contract comprising a plurality of milestones corresponding to the plurality of tasks. In one embodiment, the method includes posting each of the plurality of tasks to be bid on by third parties to complete each task of the plurality of tasks. In one embodiment, the method includes associating a third party that is granted the bid for a task with the corresponding milestone in the smart contract. In one embodiment, the method includes, in response to authenticating information evidencing completion of the task by the third party, executing a portion of the smart contract associated with the milestone corresponding to the completed task, via the blockchain, to distribute funds to the third party that completed the task.

In one embodiment, the plurality of tasks are sequential such that a second task of the plurality of tasks cannot commence until a first task of the plurality of tasks is completed and executed within the smart contract.

In one embodiment, the method includes authenticating the received information evidencing completion of the task to verify that the one or more third parties completed the task.

In one embodiment, authenticating the received information comprises transmitting the received information to a licensed escrow agent for review and verification.

In one embodiment, authenticating the received information comprises providing the received information to a machine learning model configured for authenticating the received information based on similar historical information.

In one embodiment, the method includes receiving the information evidencing completion of the task from the third party associated with the task, the evidence comprising one or more of documents, images, and videos.

In one embodiment, the method includes interfacing with one or more financial institutions to facilitate distribution of the funds for the completed task to the third party in response to the portion of the smart contract associated with the completed task being executed.

In one embodiment, interfacing with the one or more financial institutions comprises interfacing with one or more application programming interfaces (“APIs”) of the one or more financial institutions.

In one embodiment, the method includes distributing funds for the completed task in one or more of fiat currency and crypto currency.

In one embodiment, the portion of the smart contract associated with the milestone corresponding to the completed task is executed in response to receiving approval of the milestone via one or more of a web application and a mobile application.

In one embodiment, the method includes verifying one or more legal aspects of the project prior to generating the smart contract, the one or more legal aspects comprising at least one of licenses, permits, and titles.

In one embodiment, the method includes posting an offer to invest in each of the plurality of tasks and verifying that a potential investor is qualified to invest in a task prior to approving the task to be worked on.

In one embodiment, the method includes verifying the third parties bidding on the plurality of tasks, the verification comprising verifying licenses, credentials, and reviews of the third parties.

In one embodiment, the method includes presenting an interactive graphical user interface comprising a graphical visualization of geographic locations where projects are being completed.

An apparatus for smart contract-based project development using milestone based distribution is disclosed. In one embodiment, the apparatus includes a processor and a memory that stores code executable by the processor. In one embodiment, the code executable by the processor to generate a smart contract, using blockchain, for a project comprising a plurality of tasks, the smart contract comprising a plurality of milestones corresponding to the plurality of tasks. In one embodiment, the code executable by the processor to post each of the plurality of tasks to be bid on by third parties to complete each task of the plurality of tasks. In one embodiment, the code executable by the processor to associate a third party that is granted the bid for a task with the corresponding milestone in the smart contract. In one embodiment, the code executable by the processor to, in response to authenticating information evidencing completion of the task by the third party, execute a portion of the smart contract associated with the milestone corresponding to the completed task, via the blockchain, to distribute funds to the third party that completed the task.

In one embodiment, the plurality of tasks are sequential such that a second task of the plurality of tasks cannot commence until a first task of the plurality of tasks is completed and executed within the smart contract.

In one embodiment, the code is executable by the processor to authenticate the received information evidencing completion of the task to verify that the one or more third parties completed the task.

In one embodiment, authenticating the received information comprises transmitting the received information to a licensed escrow agent for review and verification.

In one embodiment, authenticating the received information comprises providing the received information to a machine learning model configured for authenticating the received information based on similar historical information.

A computer program product for smart contract-based project development using milestone based distribution is disclosed. In one embodiment, the computer program product includes a non-transitory computer readable storage medium having program code embodied therein. In one embodiment, the program code executable by a processor for generating a smart contract, using blockchain, for a project comprising a plurality of tasks, the smart contract comprising a plurality of milestones corresponding to the plurality of tasks. In one embodiment, the program code executable by a processor for posting each of the plurality of tasks to be bid on by third parties to complete each task of the plurality of tasks. In one embodiment, the program code executable by a processor for associating a third party that is granted the bid for a task with the corresponding milestone in the smart contract. In one embodiment, the program code executable by a processor for, in response to authenticating information evidencing completion of the task by the third party, executing a portion of the smart contract associated with the milestone corresponding to the completed task, via the blockchain, to distribute funds to the third party that completed the task.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for smart contract-based project development using milestone based distribution;

FIG. 2 is a block diagram illustrating one embodiment of an apparatus for smart contract-based project development using milestone based distribution;

FIG. 3 is a block diagram illustrating one embodiment of an apparatus for smart contract-based project development using milestone based distribution;

FIG. 4 is a schematic flow chart diagram illustrating one embodiment of a method for smart contract-based project development using milestone based distribution; and

FIG. 5 is a schematic flow chart diagram illustrating one embodiment of another method for smart contract-based project development using milestone based distribution.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

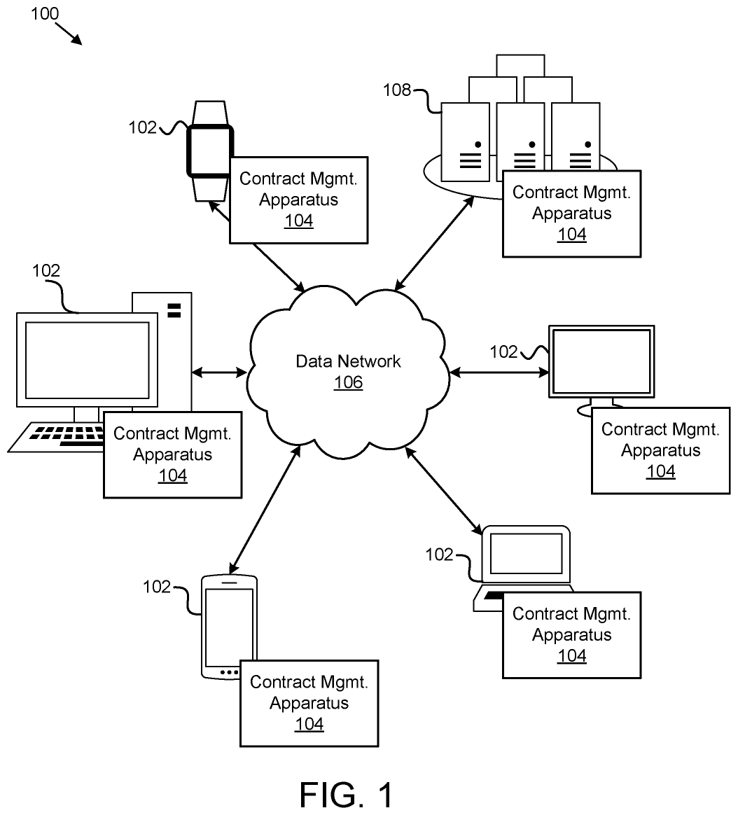

FIG. 1 is a schematic block diagram illustrating one embodiment of a system 100 for programmable construction using smart contracts with escrow distribution and verification by professionals. In one embodiment, the system 100 includes one or more information handling devices 102, one or more contract management apparatuses 104, one or more data networks 106, and one or more servers 108. In certain embodiments, even though a specific number of information handling devices 102, contract management apparatuses 104, data networks 106, and servers 108 are depicted in FIG. 1, one of skill in the art will recognize, in light of this disclosure, that any number of information handling devices 102, contract management apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In certain embodiments, the information handling devices 102 are configured to host, execute, facilitate, and/or the like online presentations such as real-time livestream video or audio conferences, pre-recorded presentations that are streamed from a network such as the Internet, and/or the like. In such an embodiment, the information handling devices 102 may be equipped with speakers, microphones, display devices, and/or the like that are used to participate in, supervise, conduct, and/or the like an online presentation.

In general, in one embodiment, the contract management apparatus 104 is configured to generate a smart contract, using blockchain, for a project comprising a plurality of tasks, the smart contract comprising a plurality of milestones corresponding to the plurality of tasks, post each of the plurality of tasks to be bid on by third parties to complete each task of the plurality of tasks, associate a third party that is granted the bid for a task with the corresponding milestone in the smart contract, and, in response to authenticating information evidencing completion of the task by the third party, execute a portion of the smart contract associated with the milestone corresponding to the completed task, via the blockchain, to distribute funds to the third party that completed the task. The contract management apparatus 104 is described in more detail below.

As an example application of the subject matter disclosed herein, a smart contract for a construction project, or other project, may be used by incorporating licensed professionals into the process, e.g., general contractor, subcontractor, inspector, escrow agent, and/or the like, where the licensed professional uploads proof, evidence, or the like of completed tasks for the project, which then triggers or causes subsequent steps defined by a smart contract to be performed, occur, start, begin, happen, or the like, and/or causes distribution of funds to the licensed professional for the services rendered. There is a need for an information technology platform that facilitates container-based smart contract systems for executing real world tasks using licensed professionals and administrators, powered by blockchain technology.

In certain embodiments, the contract management apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the contract management apparatus 104 may include a power interface, a wired and/or wireless network interface, a graphical interface that attaches to a display, and/or a semiconductor integrated circuit device as described below, configured to perform the functions described herein with regard to the contract management apparatus 104.

The contract management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the contract management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the contract management apparatus 104.

The semiconductor integrated circuit device or other hardware appliance of the contract management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the contract management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to execute programs, applications, or other instructions for creating smart contracts and utilizing blockchain.

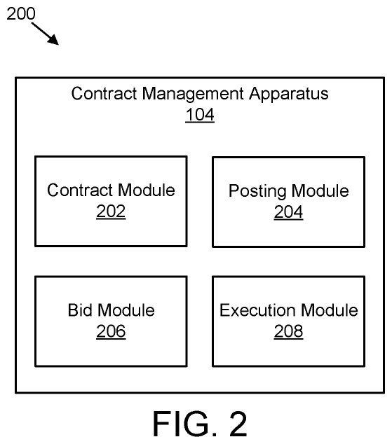

FIG. 2 is a schematic block diagram illustrating one embodiment of an apparatus 200 for smart contract-based project development using milestone based distribution. In one embodiment, the apparatus 200 includes an instance of a contract management apparatus 104. In one embodiment, the contract management apparatus 104 includes one or more of a contract module 202, a posting module 204, a bid module 206, and an execution module 208, which are described in more detail below.

In one embodiment, the contract module 202 is configured to generate a smart contract, using blockchain, for a project comprising a plurality of tasks. As used herein, smart contracts comprise lines of code that are stored on a blockchain and automatically execute when predetermined terms and conditions are met. At the most basic level, they are programs that execute as they have been designed to run by the people who developed them. Smart contracts are protocols used to facilitate, verify, and/or enforce contracts on a digital medium. The self-executing contracts can be safely executed and authenticated without third parties and cannot be reversed. Each transaction is documented on a blockchain or distributed ledger system as well, increasing traceability and transparency across the ledger.

For instance, companies use smart contracts to improve the security of transactions. Smart contracts are heavily encrypted and provide superior protection over standard encryption technology. Their self-executing nature can speed up transactions and increase accuracy as well. Smart contracts also improve transparency since requirements are well defined and transactions are all documented and irreversible.

Some blockchain platforms and blockchain payment solutions offer smart contracts or allow users to create, manage, and execute transactions digitally. Conventional solutions are limited and restricted to their conventional architecture and installation system. These conventional solutions have considerable shortcomings that adversely affect the convenience with which they can be used.

For instance, traditional service contracts, even electronic contracts, are between a single consumer and a single provider. No mechanisms currently exist to permit multiple parties to consider and attach to a proposed or established contract. And while some examples of smart contracts exist, current implementations are problematic regarding efficient update of the “smart” terms, inconsistent oversight of the smart terms, as well as the overall contract impact when dynamically modifying terms, among many other problems. As a result, smart contracts are not widely adopted or trusted, and certainly not available for a large and potentially fluctuating number of parties to join.

As described above, the smart contract as used herein is built upon or utilizes blockchain technology. As used herein, blockchain refers to a distributed database that is shared among nodes (e.g., computing devices such as servers) of a computer network. As a database, a blockchain stores information electronically in digital format. The innovation with a blockchain is that it guarantees the fidelity and security of a record of data and generates trust without the need for a trusted third party. As it applies to smart contracts, blockchain stores the executable code of the self-executing contract, including the terms and agreements, across a distributed, decentralized blockchain network. The code controls the execution, and the transactions are trackable and irreversible. Importantly, smart contracts permit trusted transactions and agreements to be carried out among disparate, anonymous parties without the need for a central authority, legal system, or external enforcement mechanism.

In one embodiment, the smart contract includes a plurality of milestones corresponding to the plurality of tasks. The plurality of tasks, for example, may include tasks for completing a construction project such as tasks for excavation, foundation preparation, framing, plumbing, electrical wiring, roofing, drywall, finish work, and/or the like. The milestones may correspond to different checkpoints in the progress of the project, e.g., different funding points where once a milestone is completed, the funds set aside for the milestone are distributed. In one embodiment, the milestones are logical containers that include a plurality of tasks such that the funding for a completed task is not distributed until a milestone that includes the completed task is completed.

For instance, the plurality of tasks may be sequential such that a second task of the plurality of tasks cannot commence until a first task of the plurality of tasks is completed and executed within the smart contract. For example, continuing with the construction example, the foundation cannot be laid until excavation is complete; the plumbing cannot be completed until the framing is complete, and so on. Thus, the milestones may correspond to the different steps in the process that are each associated with a task. Each task may be coded in the smart contract and implemented using a blockchain distributed database such that when a task is completed, the code for the task in the smart contract is executed and recorded in the blockchain, as described in more detail below.

In certain embodiments, new tasks may be dynamically added to the smart contract during the process of completing the project, e.g., to account for unforeseen issues, modifications, adjustments, and/or the like to the original plans. The contract module 202 allows for new tasks or milestones to be created within the smart contract after work on the project or milestone has commenced. In this manner, the smart contract may include dynamic and static tasks or milestones for completing a project.

In one embodiment, the posting module 204 is configured to post each of the plurality of tasks to be bid on by third parties to complete each task of the plurality of tasks. The tasks may be posted online via a web application, a web page, a mobile application, a social network, an online job board, and/or the like. The tasks may be posted with information about the project and the role of the task towards completing the project; the task requirements such as estimated man hours, material/equipment/tools required, time to complete the task, licenses/certifications required, experience required, insurance requirements, and/or the like; estimated cost and/or payout for completing the task; the amount of time that the task is open for bid; and/or the like.

In one embodiment, the posting module 204 may post offers to invest in the project, milestone, or task. The posting module 204 may target potential investors, venture capitalists, angel investors, and/or private investors with solicitations to invest in the project, within the regulations established by the governing agency, e.g., the securities and exchange commission. The posting module 204 may target potential investors using targeted advertising online (e.g., posting advertisements on financial websites), social media, and/or the like.

In one embodiment, the bid module 206 is configured to associate a third party that is granted the bid for a task with the corresponding milestone in the smart contract. In such an embodiment, the bid module 206 may present a graphical interface, portal, gateway, or the like, for a professional bidding on a task to enter the bid information for submitting a bid to complete the task. For instance, the bid module 206 may present an online form to collect the professional's contact information, bid amount, general information about the professional, registration/certification information (e.g., a place to upload the professional's licenses, certifications, and/or insurance), and/or the like.

After the bid period is closed, and a winner is selected, the bid module 206 associates the third party professional that entered the winning bid with the task and associates the third party with the task in the smart contract such that when the task is completed, the corresponding code in the smart contract is executed for the particular task, which may include distributing funds to the third party according to the contract terms and the submitted bid amount.

In one embodiment, the execution module 208 is configured to execute a portion of the smart contract associated with the milestone corresponding to the completed task, or a plurality of tasks within the milestone, via the blockchain, to distribute funds to the third party that completed the task. In one embodiment, the execution module 208 executes the portion of the smart contract for a completed task in response to a trigger, such as an approved authentication of information evidencing completion of the task by the third party, a signal from a web application or mobile application to execute the code (e.g., initiated by an authorized user or in an automated way such as in response to the verification of the uploaded evidence information), and/or the like.

In one embodiment, the execution module 208 interfaces with one or more financial institutions to distribute funds for the completed task in one or more of fiat currency and crypto currency. The execution module 208, for example, may interface with a bank, credit union, or other lending or financial institution to facilitate the transfer of funds from an account set up for the project to the professional(s) that completed a task to an account of the third party. The smart contract may have a portion of code that is designed to facilitate such a transaction when executed without further user intervention or input.

In such an embodiment, the execution module 208 interfaces with one or more financial institutions using one or more application programming interfaces (“APIs”) of the one or more financial institutions. In further embodiments, the execution module 208 may specify that payment be made using fiat currency and/or crypto currency. For instance, the execution module 208 may facilitate the payment of currency from an account at one financial institution to the third party's account at another financial institution and may specify what percentage of the funds to be paid in fiat currency, e.g., U.S. dollars, and what percentage to be paid in crypto currency, e.g., Bitcoin.

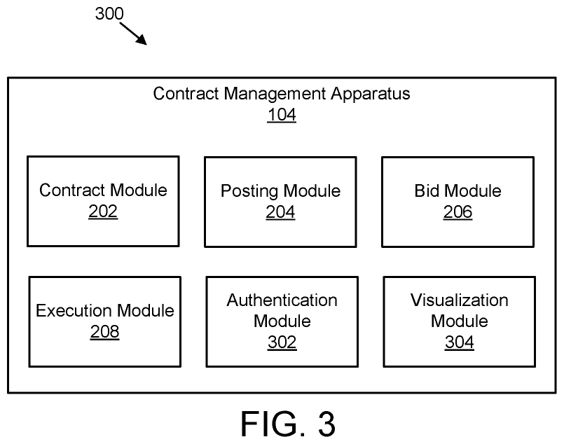

FIG. 3 is a schematic block diagram illustrating one embodiment of an apparatus 300 for smart contract-based project development using milestone based distribution. In one embodiment, the apparatus 300 includes an instance of a contract management apparatus 104. In one embodiment, the contract management apparatus 104 includes one or more of a contract module 202, a posting module 204, a bid module 206, and an execution module 208, which may be substantially similar to the contract module 202, the posting module 204, the bid module 206, and the execution module 208 described above with reference to FIG. 2. Moreover, the contract management apparatus 104 may include one or more of an authentication module 302 and a visualization module 304, which are described in more detail below.

The authentication module 302, in one embodiment, is configured to authenticate and/or verify information evidencing completion of the task to verify that the one or more third parties completed the task. For instance, a third party, after completing a task, may submit evidence that the task is completed, which may include images, videos, documents, and/or the like. The authentication module 302 may provide a graphical interface, such as a form, for uploading and submitting such documentation. Upon approval by the authentication module 302 that the information is legitimate and clearly proves or shows completion of a task, the portion of the smart contract associated with the task may be executed (or flagged as completed within a milestone such that when the milestone is completed the funds are distributed to the third party that completed the task).

In one embodiment, the authentication module 302 forwards, transmits, or otherwise provides the submitted evidence to a licensed escrow agent or other professional, for review and verification. For example, the authentication module 302 may make documentation available within an online portal or interface or may email the documentation to the licensed escrow agent. The licensed escrow agent may then approve or deny the documentation, may submit a request for additional documentation, and/or the like via a mobile application or web application, which may trigger execution of the portion of the code of the smart contract associated with the completed task.

In one embodiment, the authentication module 302 provides the received information to a machine learning model configured for authenticating the received information based on similar historical information. For instance, a machine learning model may be specially trained for analyzing content that is typically used to verify completion of a task such as images, videos, and/or documents. The machine learning model may be trained using historical training data that comprises similar images, videos, and documents that are typically used to verify completion of a task such as work orders, inspection documents, before and after images/videos, and/or the like. The authentication module 302 may then provide the received evidence content to the machine learning model, where it is processed and analyzed to predict, estimate, determine a likelihood, or the like of the evidence being legitimate and/or verifying completion of the project.

In one embodiment, the machine learning model may be used to determine a score, probability, rank, or the like that the submitted evidence is legitimate and also verifies completion of the project, which may be provided to a licensed escrow agent for a secondary review or to narrow the scope of the licensed escrow agents review (e.g., to flag certain areas that may be deficient). Furthermore, the machine learning model may generate recommendations or suggestions for approving the evidence or for requesting additional information (e.g., more pictures, clearer pictures, certain documents, or the like). In this manner, the machine learning model may provide information or at least a partial review of the evidence for the licensed escrow agent to use. Thus, the authentication module 302 may train and create a machine learning model that is specially configured for a particular project, milestone, or task based on historical information that is associated with or has previously been uploaded for similar projects, milestones, and tasks and is not merely a general-purpose machine learning model.

In one embodiment, the authentication module 302 verifies one or more legal aspects of the project prior to generating the smart contract. For instance, a project creator may be a developer and the authentication module 302 may first verify that the developer has legal right in the property asset that is the subject of the project, which may include analyzing, verifying, reviewing, or the like at least one of licenses, permits, and titles. In such an embodiment, the authentication module 302 may automatically reference public records databases, e.g., via an API to the recorder's office or other governmental agency, to verify that the entered information and/or uploaded documents are legitimate and that the project creator has legal rights to the asset that is the subject of the project.

In one embodiment, the authentication module 302 verifies the third parties bidding on the plurality of tasks. In such an embodiment, the verification comprises verifying licenses, credentials, and reviews of the third parties. For instance, the authentication module 302 may interface with a public records database, e.g., via an API to a government or licensing agency, to verify that the third-party professional that is bidding to work on a task is legitimate, e.g., is licensed, certified, insured, and/or the like, prior to allowing them to bid on a task. In further embodiments, the authentication module 302 may access and parse online reviews (e.g., Google reviews) of the third-party professionals bidding on a project to verify that the third-party professional has reviews that satisfy a predetermined threshold prior to allowing them to bid on a task.

Further, in one embodiment, the authentication module 302 verifies potential investors that are investing in a project or task are qualified to invest in the project or task prior to approving the project or task to be completed. For instance, the authentication module 302 may present a form for the potential investor to submit qualifying documentation and information to verify that they are an accredited investor, or a different level of investor, that allows them to invest in the project or task. The authentication module 302 may access public or other records to verify the potential investor's information and claims prior to approving the project or task for completion to prevent unauthorized investors from investing in the project.

In one embodiment, the visualization module 304 is configured to generate a graphical representation of various projects that are being bid on/slated to be completed, projects that are currently under construction, and/or the like. The graphical visualization, for example, may include a graphical map that includes icons representing projects at different geographic locations. The graphical map may be interactive such that a user may click on an icon to see information about the project, e.g., the current stage of the project, the goal/end point of the project, who is investing in the project, who is working on the project, who developed the project, and/or the like. The graphical representation may be visible within a web application, a mobile application, and/or the like.

In general, in one embodiment, the contract management apparatus 104, as described above, is configured to provide a novel and improved form of an information technology platform that facilitates for electronic contracts. In certain embodiments, the contract management apparatus 104 is configured to provide an improved form of a method that includes defining the terms of the contract, both dynamically and statically. The method can include identifying the consumers interested in contracting for a good or service.

In one embodiment, the contract management apparatus 104 is configured to provide a new and improved structure where container-based smart contract systems (e.g., a project container includes a milestone container that includes a plurality of tasks) for executing real-world tasks using licensed professionals and administrators are utilized, powered by blockchain technology. In one embodiment, the contract management apparatus 104 is configured to provide a so-called playground to build transactions from scratch using modules. In one embodiment, the contract management apparatus 104 is configured to compute and present the potential development structures that employ recipe systems that provide templates for different types of transactions.

As used herein, the subject matter describes an assembly that includes stackable components (e.g., projects, milestones, tasks) that include functions within each container consisting of an objective (e.g., a task) and roles involved in the execution (e.g., a third-party professional providing the service). The stackable components represent steps in the transaction process where each stackable component has its own objective or function that it is responsible for carrying out. Tasks are executed by a licensed professional or administrator role. Once the work has been completed successfully in the real world, the professional uploads proof (e.g., agreements, receipts, images, or other supporting documentation) to the system, e.g., the contract management apparatus 104.

Stackable components may be stacked together to build a transaction. Containers, as per further embodiments are made up of stacked components and represent the project in its entirety. Recipes, as used herein, are premade templates for types of transactions or projects. Recipes can be created to execute additional types of transactions beyond construction, which consist of multiple containers stacked as part of the smart contract. For a smart contract to fully execute to completion, all steps in the process must be verified in order to progress to the next stage of the transaction.

In one example, a construction project may cost $200,000 to complete, and a general contractor may be hired for overseeing completion of the project. The general contractor may submit a construction bid that breaks down the costs and timelines for competing the project. In this example, a smart contract may be created on the blockchain where the project is split into four phases/milestones, with distributions of $50,000 associated with each phase such that when the general contractor submits proof of completion of one phase, which may require additional proof submitted by inspectors, or the like, (e.g., submitting to the blockchain using a protocol such as interplanetary file system (“IPFS”) an inspection report or the like that indicates the project to that point is completed satisfactorily), the smart contract will trigger or cause an additional $50,000 to be distributed for the next phase. In certain embodiments, contract management apparatus 104 may remove an escrow agent from the process such that the transactions and funds are verified and distributed without authorization or verification by a user such as an escrow agent, e.g., using machine learning or other automated resources.

In one embodiment, the contract management apparatus 104 is configured to provide a platform for quadratic voting. As used herein, quadratic voting is a collective decision-making procedure which involves individuals allocating votes to express the degree of their preferences, rather than just the direction of their preferences. By doing so, quadratic voting helps enable users to address issues of voting paradox and majority rule. Quadratic voting works by allowing users to “pay” for additional votes on a given matter to express their support for given issues more strongly, resulting in voting outcomes that are aligned with the highest willingness to pay outcome, rather than just the outcome preferred by the majority regardless of the intensity of individual preferences.

For example, as it relates to the subject matter herein, a smart contract may be created for different proposed campaigns or projects such as filling in a pothole in a street. In such an example, a campaign defined by a smart contract may be created for filling the pothole, users can vote using quadratic voting on whether the pothole should be filled, with funds from the purchase of additional votes going to the campaign. When a threshold number of votes or amount of funds is reached and verified by the smart contract, using blockchain, the funds can be distributed to an entity that has bid on working on the project. As with the construction example above, the smart contract may split the project into different milestones and the funds may also be split for each milestone such that when proof of completion of one milestone is submitted and verified, the next portion of the funds can be distributed and used for the next milestone, and so on.

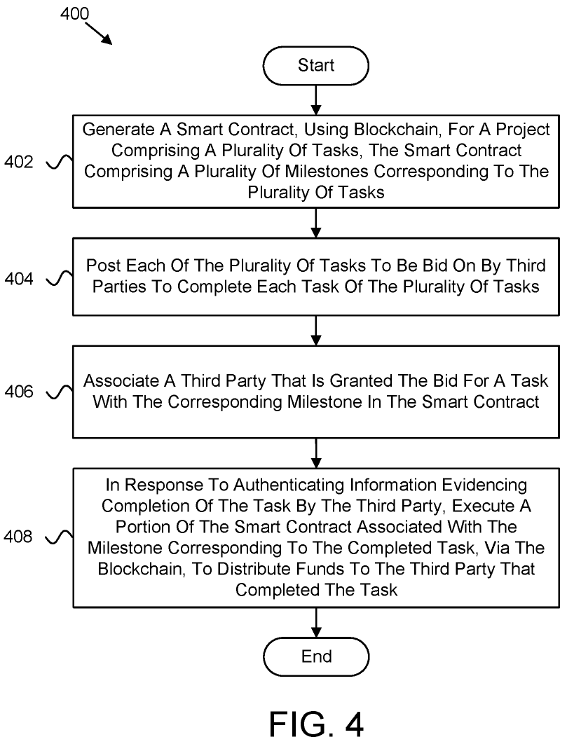

FIG. 4 is a schematic flow chart diagram illustrating on embodiment of a method for smart contract-based project development using milestone based distribution. In one embodiment, the method 400 begins and generates 402 a smart contract, using blockchain, for a project comprising a plurality of tasks, the smart contract comprising a plurality of milestones corresponding to the plurality of tasks. In one embodiment, the method 400 posts 404 each of the plurality of tasks to be bid on by third parties to complete each task of the plurality of tasks. In one embodiment, the method 400 associates 406 a third party that is granted the bid for a task with the corresponding milestone in the smart contract. In one embodiment, the method 400, in response to authenticating information evidencing completion of the task by the third party, executes 408 a portion of the smart contract associated with the milestone corresponding to the completed task, via the blockchain, to distribute funds to the third party that completed the task, and the method 400 ends. In one embodiment, the steps of the method 400 are performed by the contract module 202, the posting module 204, the bid module 206, and the execution module 208 described above.

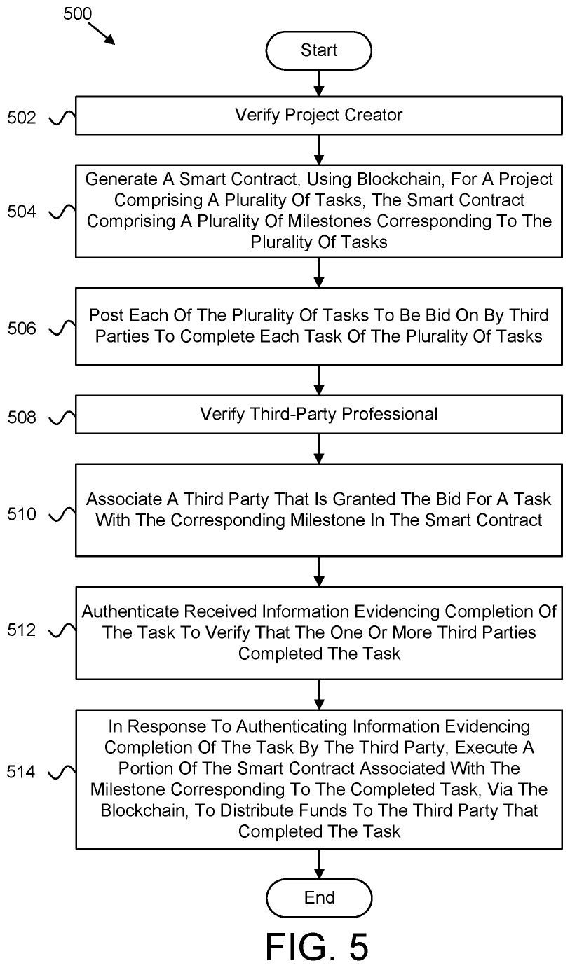

FIG. 5 is a schematic flow chart diagram illustrating on embodiment of a method for smart contract-based project development using milestone based distribution. In one embodiment, the method 500 begins and verifies 502 a user creating a project to be bid on and completed. The verification may include verifying credentials, legal instruments, and/or other documentation.

In one embodiment, in response to verifying the project creator, the method 500 generates 504 a smart contract, using blockchain, for a project comprising a plurality of tasks, the smart contract comprising a plurality of milestones corresponding to the plurality of tasks. In one embodiment, the method 500 posts 506 each of the plurality of tasks to be bid on by third parties to complete each task of the plurality of tasks.

In one embodiment, the method 500 verifies 508 a third-party professional that submits a bid to work on a task associated with completion of the project. The verification may include verifying credentials, licenses, insurance, legal instruments, and/or other documentation. In one embodiment, the method 500 associates 510 a third party that is granted the bid for a task, in response to verifying the third-party professional meets the requirements for working on the project, with the corresponding milestone in the smart contract.

In one embodiment, the method 500, authenticates 512 information that is received from the third-party professional that evidences completion of the task. The information may include images, videos, documents (e.g., receipts, work orders, etc.), and/or the like. The method 500 may utilize licensed escrow agents and/or machine learning to verify and authenticate the submitted evidence.

In one embodiment, in response to authenticating information evidencing completion of the task by the third party, the method 500 executes 514 a portion of the smart contract associated with the milestone corresponding to the completed task, via the blockchain, to distribute funds to the third party that completed the task, and the method 500 ends. In one embodiment, the steps of the method 500 are performed by the contract module 202, the posting module 204, the bid module 206, the execution module 208, the authentication module 302, described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
generating a smart contract, using blockchain, for a project comprising a plurality of tasks, the smart contract comprising a plurality of milestones corresponding to the plurality of tasks;
posting each of the plurality of tasks to be bid on by third parties to complete each task of the plurality of tasks;
associating a third party that is granted the bid for a task with the corresponding milestone in the smart contract; and
in response to authenticating information evidencing completion of the task by the third party, executing a portion of the smart contract associated with the milestone corresponding to the completed task, via the blockchain, to distribute funds to the third party that completed the task.

2. The method of claim 1, wherein the plurality of tasks are sequential such that a second task of the plurality of tasks cannot commence until a first task of the plurality of tasks is completed and executed within the smart contract.

3. The method of claim 1, further comprising authenticating the received information evidencing completion of the task to verify that the one or more third parties completed the task.

4. The method of claim 3, wherein authenticating the received information comprises transmitting the received information to a licensed escrow agent for review and verification.

5. The method of claim 3, wherein authenticating the received information comprises providing the received information to a machine learning model configured for authenticating the received information based on similar historical information.

6. The method of claim 1, further comprising receiving the information evidencing completion of the task from the third party associated with the task, the evidence comprising one or more of documents, images, and videos.

7. The method of claim 1, further comprising interfacing with one or more financial institutions to facilitate distribution of the funds for the completed task to the third party in response to the portion of the smart contract associated with the completed task being executed.

8. The method of claim 6, wherein interfacing with the one or more financial institutions comprises interfacing with one or more application programming interfaces (“APIs”) of the one or more financial institutions.

9. The method of claim 6, further comprising distributing funds for the completed task in one or more of fiat currency and crypto currency.

10. The method of claim 1, wherein the portion of the smart contract associated with the milestone corresponding to the completed task is executed in response to receiving approval of the milestone via one or more of a web application and a mobile application.

11. The method of claim 1, further comprising verifying one or more legal aspects of the project prior to generating the smart contract, the one or more legal aspects comprising at least one of licenses, permits, and titles.

12. The method of claim 1, further comprising posting an offer to invest in each of the plurality of tasks and verifying that a potential investor is qualified to invest in a task prior to approving the task to be worked on.

13. The method of claim 1, further comprising verifying the third parties bidding on the plurality of tasks, the verification comprising verifying licenses, credentials, and reviews of the third parties.

14. The method of claim 1, further comprising presenting an interactive graphical user interface comprising a graphical visualization of geographic locations where projects are being completed.

15. An apparatus, comprising:
a processor; and
a memory that stores code executable by the processor to:
generate a smart contract, using blockchain, for a project comprising a plurality of tasks, the smart contract comprising a plurality of milestones corresponding to the plurality of tasks;
post each of the plurality of tasks to be bid on by third parties to complete each task of the plurality of tasks;
associate a third party that is granted the bid for a task with the corresponding milestone in the smart contract; and
in response to authenticating information evidencing completion of the task by the third party, execute a portion of the smart contract associated with the milestone corresponding to the completed task, via the blockchain, to distribute funds to the third party that completed the task.

16. The apparatus of claim 15, wherein the plurality of tasks are sequential such that a second task of the plurality of tasks cannot commence until a first task of the plurality of tasks is completed and executed within the smart contract.

17. The apparatus of claim 15, wherein the code is executable by the processor to authenticate the received information evidencing completion of the task to verify that the one or more third parties completed the task.

18. The apparatus of claim 17, wherein authenticating the received information comprises transmitting the received information to a licensed escrow agent for review and verification.

19. The apparatus of claim 17, wherein authenticating the received information comprises providing the received information to a machine learning model configured for authenticating the received information based on similar historical information.

20. A computer program product comprising a non-transitory computer readable storage medium having program code embodied therein, the program code executable by a processor for:
generating a smart contract, using blockchain, for a project comprising a plurality of tasks, the smart contract comprising a plurality of milestones corresponding to the plurality of tasks;
posting each of the plurality of tasks to be bid on by third parties to complete each task of the plurality of tasks;
associating a third party that is granted the bid for a task with the corresponding milestone in the smart contract; and
in response to authenticating information evidencing completion of the task by the third party, executing a portion of the smart contract associated with the milestone corresponding to the completed task, via the blockchain, to distribute funds to the third party that completed the task.
